(19) United States
(12) Patent Application Publication
(10) Pub. No.: US 2013/0174044 A1
(43) Pub. Date: Jul. 4, 2013

(54) METHODS AND APPARATUS TO CONTROL PRESENTATION DEVICES

(71) Applicant: Thomas Casey Hill, Crystal Lake, IL (US)

(72) Inventor: Thomas Casey Hill, Crystal Lake, IL (US)

(21) Appl. No.: 13/635,305

(22) PCT Filed: Nov. 22, 2011
(86) PCT No.: PCT/US11/61935

§ 371 Date: Sep. 14, 2012

(51) Int. Cl. H04L 29/06

(52) U.S. Cl. CPC H04L 65/40
USPC 715/740

(57) ABSTRACT

Example methods and apparatus to control presentation devices are described. One example method includes establishing a communication link between a mobile device and a first external presentation device, receiving, via a user interface of the mobile device, a first selection of a first application to be displayed on a destination external presentation device, receiving, at the mobile device, a first indication via the communication link that the first external presentation device was selected as the destination external presentation device for the first application, and causing the first application to be displayed on the first external presentation device.

### FIELD OF THE DISCLOSURE

The present disclosure relates generally to mobile devices and, more particularly, to methods and apparatus to control presentation devices.

### BACKGROUND

It would be useful to provide a first electronic device which may be communicatively coupled with a second electronic device to allow the first electronic device to transfer presentation of an application to the second electronic device.

### BRIEF DESCRIPTION OF THE DRAWINGS

FIG. 1 illustrates an example system in which a mobile device is communicatively coupled with an external presentation device.

FIG. 2 illustrates an example controller to manage assignment of an application from a mobile device to an external presentation device.

FIGS. 3 and 4 illustrate example flow diagrams representative of methods, which may be implemented using computer readable instructions, that may manage the assignment of an application from a mobile device to an external presentation device.

FIGS. 5A, 5B, and 5C illustrate example implementations in accordance with the disclosure.

FIG. 6 is a block diagram of a mobile device in accordance with an example embodiment.

### DETAILED DESCRIPTION

A first electronic device may be communicatively coupled with a second electronic device to allow the first electronic device to transfer presentation of an application to the second electronic device. For example, the mobile device may transfer a presentation of an application executing on the mobile device to an external presentation device. The presentation may include audio, video, graphics, images, text, etc. As the electronic device is operated, the electronic device may be communicatively coupled with several electronic devices to which presentation of an application could be transferred.

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

For simplicity and clarity of illustration, where considered appropriate, reference numerals may be repeated among the figures to indicate corresponding or analogous elements. In addition, numerous specific details are set forth in order to provide a thorough understanding of examples disclosed herein. However, it will be understood by those of ordinary skill in the art that examples disclosed herein may be practiced without these specific details. In other instances, well-known methods, procedures and components have not been described in detail so as not to obscure examples disclosed herein. Also, the description is not to be considered as limiting the scope of examples disclosed herein.

Example methods, apparatus, and articles of manufacture disclosed herein may be used in connection with telephony-capable mobile devices, which may be any mobile communication device, mobile computing device, or any other element, entity, device, or service capable of communicating wirelessly. Mobile devices, also referred to as terminals, wireless terminals, mobile stations, communication stations, user equipment (UE), or user devices, may include mobile smartphones (e.g., BlackBerry® smartphones), cellular telephones, wireless personal digital assistants (PDA), tablet/laptop/notebook/netbook computers with wireless adapters, etc.

Example method, apparatus, and articles of manufacture disclosed herein facilitate the control of presentation devices communicatively coupled to a mobile device. In one example, such methods may include establishing a communication link from a mobile device to one or more external presentation devices, receiving selection on the mobile device of an application to be presented on the external presentation device, receiving an indication of an external presentation device on which to present the application, and assigning the application to the indicated external presentation device. In such an example, the indication of the external presentation device may be detected in response to a touch on a touch sensitive display of the external presentation device.

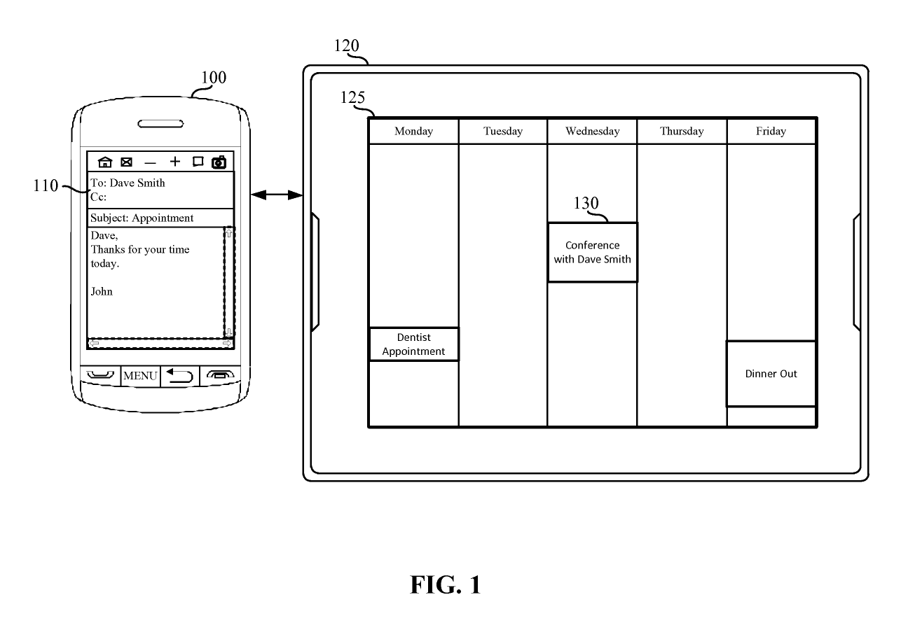

As shown in FIG. 1, mobile device 100 is communicatively coupled with an external presentation device 120. A first application 110 is presented on the mobile device 100. According to the illustrated example, the first application 110 is an e-mail application. However, any other application(s) may be presented on the mobile device 100. A second application 125 is presented on the external presentation device 120. According to the illustrated example, the second application is a calendar application that includes a scheduled event 130. However, any other application(s) may be presented on the external presentation device 120. In some examples, the first application 110 and the second application 125 may be the same.

The mobile device 100 may be any type of mobile device. In some examples, the mobile device 100 may alternatively be a non-mobile device. For example, the mobile device 100 may be a non-mobile device when the external presentation device 120 is a mobile device.

The external presentation device 120 may be any type of external presentation device. It may be a mobile device in example embodiments. According to the illustrated example, the external presentation device 120 is a tablet personal computer (also referred to herein as a tablet). Alternatively, the external presentation device 120 may be any type of mobile or non-mobile device, a monitor, a television, a laptop, a personal computer, a radio, one or more speakers, a telephone, or any device capable of presenting information such as audio, video, graphics, images, text, etc.

While a single mobile device 100 and a single external presentation device 120 are illustrated in the example of FIG. 1, any number of mobile devices and tablets may be communicatively coupled. For example, the mobile device 100 may be communicatively coupled to two or more tablets 120, the mobile device 100 may be communicatively coupled to a first external presentation device 120 in the first external presentation device 120 may be communicatively coupled to a second external presentation device 120, a first mobile device 100 may be communicatively coupled to the external presentation device 120 and a second mobile device 100 may be communicatively coupled to the external presentation device 120, and so forth.

According to the illustrated example of FIG. 1, the second application 125 is executed on the mobile device 100 and the user interface of the second application 125 is transmitted to the external presentation device 120. Alternatively, any other arrangement for execution and presentation of the second application 125 may be used. For example, the second application 125 may be executed and presented on the external presentation device 120, a first part of the second application 125 may be executed at the mobile device 100 and the second part of the second application 125 may be executed at the external presentation device 120, the second application 125 may be copied or otherwise transferred to the external presentation device 120, etc.

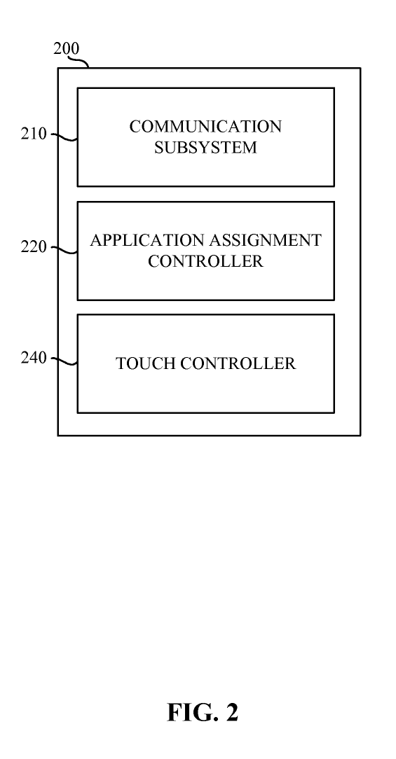

A block diagram of the example controller 200 to manage the assignment of the second application 125 to the external presentation device 120 is shown in FIG. 2. The example controller 200 includes a communication subsystem 210, and application assignment controller 220, and a touch controller 240.

Communication subsystem 210 communicatively couples the mobile device 100 with one or more external presentation device 120 to enable the mobile device 100 to assign the presentation of one or more applications to the external presentation device 120. For example, the communication subsystem 210 may receive an indication of the external presentation device 120 from the external presentation device 120, may transmit a presentation of the second application 125 to the external presentation device 120, may transmit the second application 125 to the external presentation device 120, may transmit data associated with the second application 125 to the external presentation device 120 (e.g., the scheduled event 130), etc. According to the illustrated example of FIG. 1, the communication subsystem 210 provides wireless communication. For example, the communication subsystem 210 may include a Bluetooth communication device, a near field communications (NFC) communication device, a Wi-Fi communication device, and infrared communication device, etc. Alternatively, the communication subsystem 210 may provide wired communication. In some examples, multiple wireless and/or wired communication devices may be used to communicatively couple the mobile device 100 with one or more external presentation devices 120.

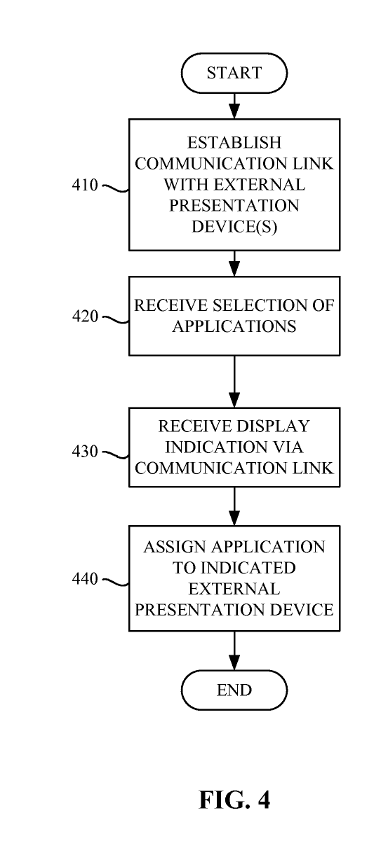

The application assignment controller 220 of the illustrated example manages the assignment of the second application 125 to the external presentation device 120. In some examples, the application assignment controller 220 assigns the second application 125 to the external presentation device 120 in response to receiving a selection of the second application 125 and receiving an indication of the external presentation device 120 via a communication link established by the communication subsystem 210. The flowchart of FIG. 4 illustrates an example of such a method.

The touch controller 240 of the illustrated example receives an indication of one or more touches and provides the indication to the application assignment controller 220. For example the touch controller 240 may receive an indication of a touch at the mobile device 100 associated with the second application 125, an indication of the touch at the external presentation device 120, or any other touch. For example, a first touch at the mobile device 100 may be associated with an icon for the second application 125, a presentation of the second application 125 at the mobile device 100, a menu item associated with the second application 125, etc. A second touch may be associated with an external presentation device (e.g., the external presentation device 120) on which the application selected by the first touch (e.g., the second application 125) is to be presented. The example touch controller 240 receives an indication of touch(es), the touch controller 240 may alternatively receive any other indication. For example, the touch controller 240 may receive an indication of activation of one or more NFC devices, a selection using any other type of user input (e.g., a mouse, a keyboard, etc.), and so forth.

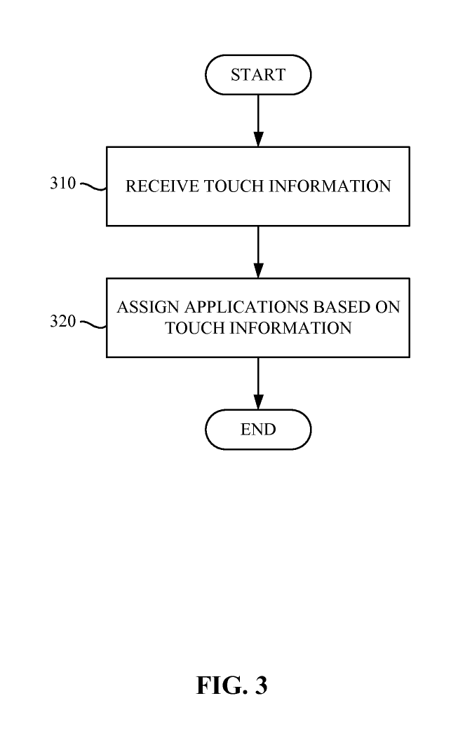

FIGS. 3 and 4 illustrate example flow diagrams representative of methods that may be implemented using, for example, computer-readable instructions stored on a computer-readable medium to control presentation devices. The example methods of FIGS. 3 and 4 may be performed using one or more processors, controllers, and/or any other suitable processing devices. For example, the example methods of FIGS. 3 and 4 may be implemented using coded instructions (e.g., computer readable instructions) stored on one or more tangible computer readable media such as flash memory, read-only memory (ROM), and/or random-access memory (RAM). For example, the mobile device 100, the external presentation device 120, the controller 200, or the processor 602 may implement the methods of FIGS. 3 and 4.

As used herein, the term tangible computer readable medium is expressly defined to include any type of computer readable storage and to exclude propagating signals. Additionally or alternatively, the example methods of FIGS. and 4 may be implemented using coded instructions (e.g., computer-readable instructions or machine-accessible instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information).

As used herein, the term non-transitory computer-readable medium and non-transitory machine-accessible medium are expressly defined to include any type of computer-readable medium or machine-accessible medium and to exclude propagating signals.

Alternatively, some or all operations of the example methods of FIGS. 3 and 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all operations of the example methods of FIGS. 3 and 4 may be implemented manually or as any combination(s) of any of the foregoing techniques, for example, any combination of firmware, software, discrete logic and/or hardware. Further, although the example methods of FIGS. 3 and 4 are described with reference to the flow diagrams of FIGS. 3 and 4, other methods of implementing the methods of FIGS. 3 and 4 may be employed. For example, the order of execution of the blocks may be changed, and/or some of the blocks described may be changed, eliminated, sub-divided, or combined. Additionally, any or all operations of the example methods of FIGS. 3 and 4 may be performed sequentially and/or in parallel by, for example, separate processing threads, processors, devices, discrete logic, circuits, etc.

In the illustrated example, the methods of FIGS. 3 and 4 are described below as performed by the mobile device 100 of FIG. 1. However, the example methods of FIGS. 3 and 4 may additionally or alternatively be implemented using external presentation device 120 of FIG. 1 or any other suitable device or apparatus.

Turning to FIG. 3, an example method to assign an application from the mobile device 100 to the external presentation device 120 is shown. The method of FIG. 3 may be implemented using, for example, computer-readable instructions or any suitable combination of hardware and/or software. The touch controller 240 of the mobile device 100 receives touch information (block 310). For example, with reference to the system of FIG. 1, the touch controller 240 receives a first touch indicative of an application (e.g., the second application 125) for which presentation is to be transmitted to an external presentation device. The touch controller 240 also receives a second touch indicative of an external presentation device to which the application is to be transmitted (e.g., the external presentation device 120). For example, the touch controller 240 may detect that the second touch occurs within a threshold time period after the first touch. Additional touches and/or user input may be provided. For example, the touch controller 240 may detect a touch and/or user input indicating that the touch controller 240 should be receptive to the first touch and the second touch (e.g., a selection option, control, button, menu item, etc. may be selected to indicate that the first touch and the second touch are forthcoming).

The application assignment controller 220 assigns the presentation of the application associated with the first touch to the external presentation device associated with the second touch (block 320).

Now turning to FIG. 4, a further example method for controlling presentation devices is shown. The communication subsystem 210 of the mobile device 100 establishes a communication link with the external presentation device 120 (block 410). The touch controller 240 receives a touch associated with an application (e.g., the second application 125) indicative of a selection of that application (block 420). Alternatively, any other indication of a selection of one or more applications may be received by the touch controller 240.

The touch controller 240 receives an indication of a touch on the external presentation device 120 (block 430). According to the illustrated example, the indication of the touch on the extra presentation device 120 is received via the communication link established in block 410. Alternatively, the indication of the touch may be received by the touch controller 240 in any other manner and/or any other type of indication may be received.

The application assignment controller 220 then assigns the selected application to the indicated external presentation device (block 440). For example, the presentation of the selected application may be assigned to the external presentation device, the application may be transferred to the external presentation device, some or all of the processing of the application may be transferred to the external presentation device, and so forth.

While the foregoing describes assigning presentation of an application from the mobile device 100 to the external presentation device 120, any other assignment may be performed. For example, the mobile device 100 because an application assigned to the external presentation device 120 to be assigned to a different external presentation device, the mobile device 100 may cause an application assigned to the external presentation device 120 to be assigned to the mobile device 100, the mobile device 100 may cause a first application to be assigned to the extra presentation device 120 and a second application to be assigned to a different extra presentation device, and so forth.

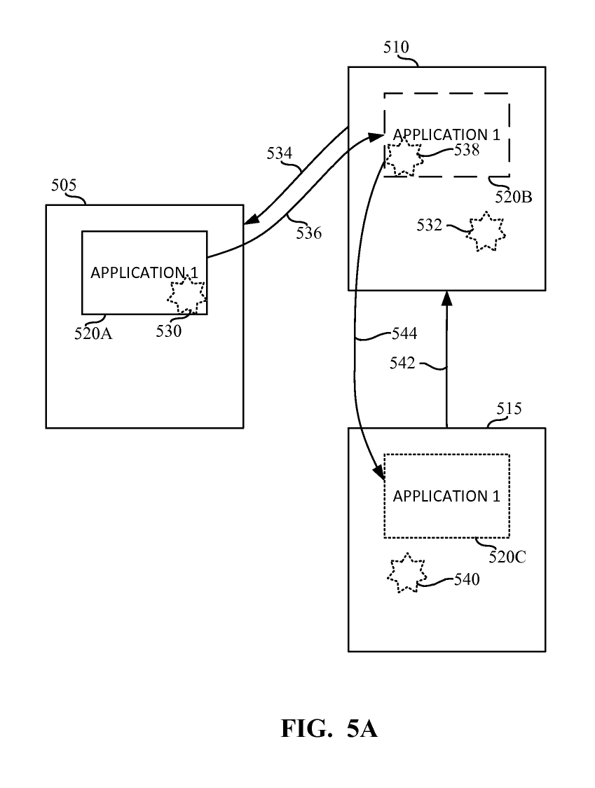

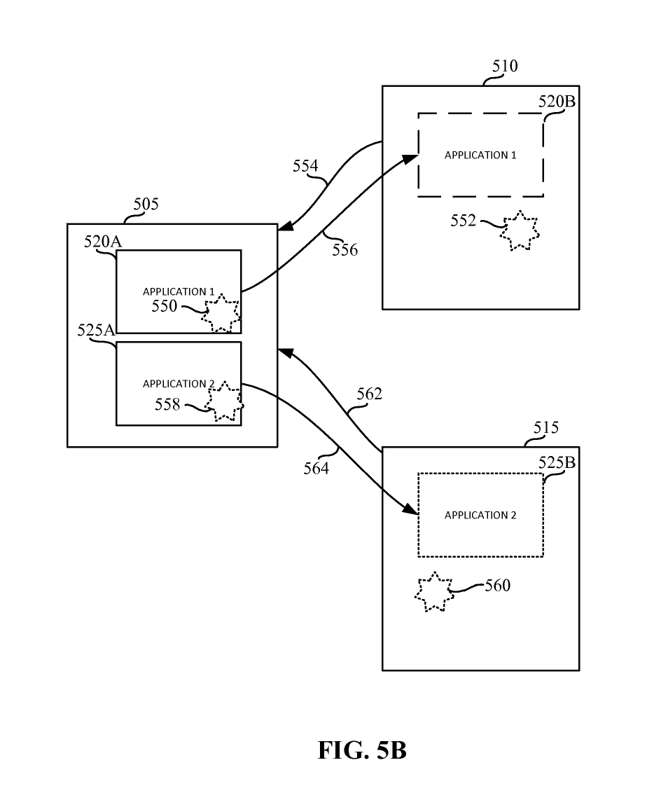

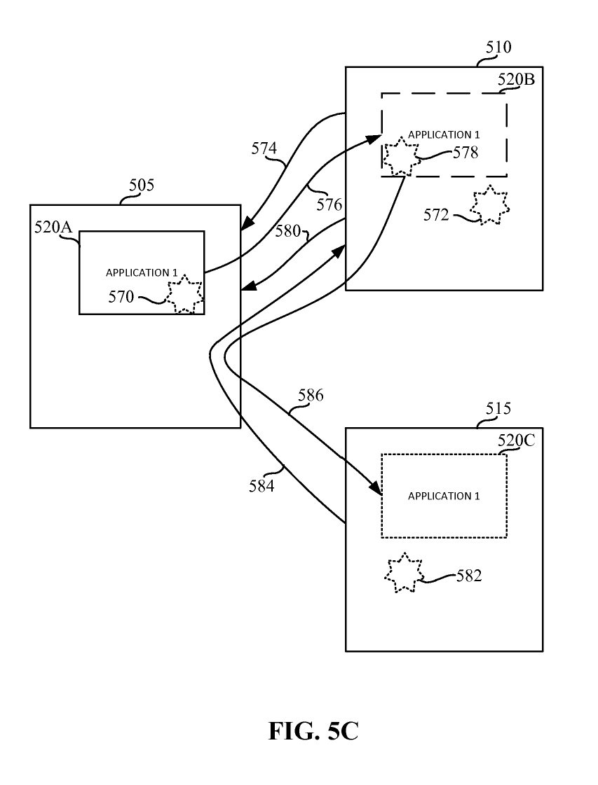

As shown in the example of FIG. 5A, presentation of an application 520A may be transferred from a mobile device 505 to a first external presentation device 510 and then to a second external presentation device 515. According to the illustrated example, a first touch 530 associated with the presentation of the application 520A is received at the mobile device 505. For example, the touch controller 240 of the mobile device 505 may receive an indication of the first touch 530. In some examples, the first touch 530 may be received after the mobile device 505 has received an indication that the first touch 530 will be received. For example, a menu item may be selected at the mobile device 505 to indicate that a user of the mobile device 505 wishes to transfer an application to an external presentation device.

According to the illustrated example, a second touch 532 associated with the first external presentation device 510 is transmitted 534 to the mobile device 505 from the first external presentation device 510. The second touch 532 indicates that the presentation of the application associated with the first touch 530 (i.e., the presentation 520A) is to be transferred to the first external presentation device 510. Accordingly, the mobile device 505 causes the presentation of the application 520A to be transmitted 536 so that the application is presented 520B at the first external presentation device 510.

According to the illustrated example, a third touch 538 associated with the presentation of the application 520B is received at the first external presentation device 510. A fourth touch 540 is received at the second external presentation device 515 and transmitted 542 to the first external presentation device 510. Accordingly, presentation of the application 520B is transmitted 544 to the second external presentation device 515 so that the application is presented 520C at the second external presentation device 515.

Presentation of application may be transmitted between devices (e.g. between a mobile device and an external presentation device or between a first external presentation device and a second external presentation device) by transmitting the presentation (i.e., a rendered presentation), by transmitting the application to be executed at the destination device, by transmitting data to be rendered for presentation at the destination device, and so forth. The transfer of an application between a first external presentation device (e.g. the first external presentation device 510) and a second external presentation device (e.g. the second external presentation device 515) may be managed by one or both of the external presentation devices and/or managed by the mobile device 505.

As shown in the example of FIG. 5B, a presentation 520A of a first application may be transferred from a mobile device 505 to a first external presentation device 510 and a presentation 525A of a second application may be transferred from the mobile device 505 to the second external presentation device 515. According to the illustrated example, a first touch 550 associated with the presentation 520A of the first application is received at the mobile device 505. A second touch 552 is received at the first external presentation device 510 and transmitted 554 to the mobile device 505. The presentation 520A of the first application is transmitted 556 to the first external presentation device 510 so that the application is presented 520B at the first external presentation device 510.

According to the illustrated example, a third touch 558 associated with the presentation 525A is received at the mobile device 505. Second touch 560 is received at the second external presentation device 515 and transmitted 562 to the mobile device 505. The presentation 525A of the second application is transmitted 564 to the second external presentation device 515 split the application is presented 525B at the second external presentation device 515.

Shown in the example of FIG. 5C, a presentation 520A of a first application may be transferred from a mobile device 505 two a first external presentation device 510 so that the application is presented 520B at the second external presentation device 510. Subsequently, the presentation 520B of the application is transferred via the mobile device 505 to a second external presentation device 515. A first touch 570 associated with the presentation 520A of the application is received at the mobile device 505. A second touch 572 is received at the first external presentation device 510 and transmitted 574 to the mobile device 505. The presentation 520A of the application is transmitted 576 to the first external presentation device 510 so that the application is presented 520B at the first external presentation device 510.

According to the illustrated example, a third touch 578 associated with the presentation of the application 520B is received at the first external presentation device 510 and transmitted 580 to the mobile device 505. A fourth touch 582 is received at the second external presentation device 515 and transmitted 584 to the first external presentation device 510 via the mobile device 505. Accordingly, presentation of the application 520B is transmitted 586 to the second external presentation device 515 so that the application is presented 520C at the second external presentation device 515.

According to the example shown in FIG. 5C, the presentation 520B of the application is transferred to the mobile device 505 prior to being transferred to the second external presentation device 515. For example, the mobile device 505 may instruct the first external presentation device 510 to discontinue presentation 520B of the application, to transmit information about the presentation 520B of the application to the mobile device 505, to transmit information about the presentation 520B of the application to the second external presentation device 515, to transmit the application to the mobile device 505, and/or any combination. Likewise, the mobile device by 505 may instruct the second external presentation device 515 to initiate presentation 520C of the application, may transmit information about presentation 520C of the application to the second external presentation device 515, and so forth.

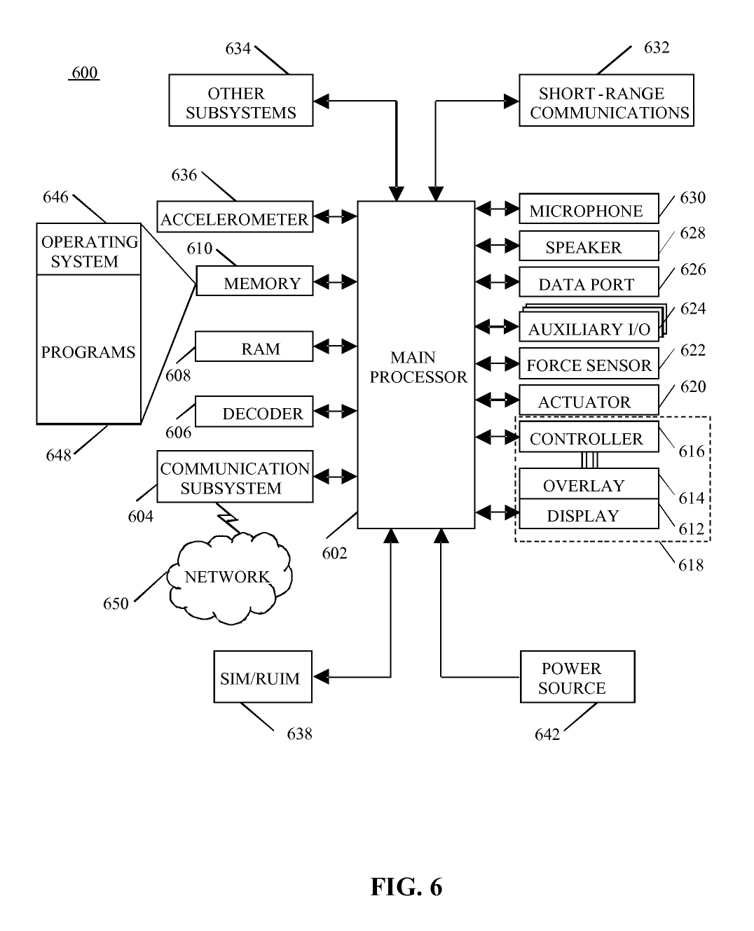

Further detail of certain aspects of the mobile devices 100 and the external presentation device 120 of FIG. 1 are shown in FIG. 6 with respect to a mobile device 600. The mobile device 600 includes multiple components, such as a main processor 602 that controls the overall operation of the mobile device 600. Communication functions, including data and voice communications, are performed through a communication subsystem 604. Data received by the mobile device 600 is decompressed and decrypted by a decoder 606. The communication subsystem 604 receives messages from and sends messages to a wireless network 650. The wireless network 650 may be any type of wireless network, including, but not limited to, data wireless networks, voice wireless networks, and networks that support both voice and data communications. A power source 642, such as one or more rechargeable batteries or a port to an external power supply, powers the mobile device 600.

The processor 602 interacts with other components, such as Random Access Memory (RAM) 608, memory 610, a display 612 with a touch-sensitive overlay 614 operably coupled to an electronic controller 616 that together include a touch-sensitive display 618, one or more actuators 620, one or more force sensors 622, an auxiliary input/output (I/O) subsystem 624, a data port 626, a speaker 628, a microphone 630, short-range communications 632, and other device subsystems 634. (In other example embodiments, there is no touch-sensitive display and therefore touch-sensitive overlay 614, electronic controller 616, actuator(s) 620 and force sensor(s) 622 are not included in mobile device 600.) In one example, the processor 602 and the memory 610 may cooperate to implement the functionality described in conjunction with the controller 200 of FIG. 2. For example, tangible and/or non-transitory, and/or machine readable instructions may be stored by the processor 602 and/or the memory 610 to implement the functionality shown in FIGS. 3 and 4.

Input via a graphical user interface is provided via the touch-sensitive overlay 614 (or in example embodiments in which there is no touch-sensitive display, input is provided via auxiliary input/output (I/O) subsystem 624). The processor 602 interacts with the touch-sensitive overlay 614 (or auxiliary input/output (I/O) subsystem 624) via the electronic controller 616. Information, such as text, characters, symbols, images, icons, and other items that may be displayed or rendered on a mobile device, is displayed on display 612 via the processor 602. The processor 602 may interact with an accelerometer 636 that may be utilized to detect direction of gravitational forces or gravity-induced reaction forces.

To identify a subscriber for network access, the mobile device 600 may utilize a Subscriber Identity Module or a Removable User Identity Module (SIM/RUIM) card 638 for communication with a network, such as the wireless network 650. Alternatively, user identification information may be programmed into memory 610.

The mobile device 600 includes an operating system 646 and software programs, applications, or components 648 that are executed by the processor 602 and are typically stored in a persistent, updatable store such as the memory 610. Additional applications or programs may be loaded onto the mobile device 600 through the wireless network 650, the auxiliary I/O subsystem 624, the data port 626, the short-range communications subsystem 632, or any other suitable subsystem 634.

The mobile device 600 also includes a camera 650 and a projector 652. As described above, the camera 650 and the projector 652 may interoperate to present information, wherein the presentation may be coordinated between several mobile devices.

A received signal such as a text message, an e-mail message, or web page download is processed by the communication subsystem 604 and input to the processor 602. The processor 602 processes the received signal for output to the display 612 and/or to the auxiliary I/O subsystem 624. A subscriber may generate data items, for example e-mail messages, which may be transmitted over the wireless network 650 through the communication subsystem 604. For voice communications, the overall operation of the mobile device 600 is similar. The speaker 628 outputs audible information converted from electrical signals, and the microphone 630 converts audible information into electrical signals for processing.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method comprising:
establishing a communication link between a mobile device and a first external presentation device;
receiving, via a user interface of the mobile device, a first selection of a first application to be displayed on a destination external presentation device;
receiving, at the mobile device, a first indication via the communication link that the first external presentation device was selected as the destination external presentation device for the first application; and
causing the first application to be displayed on the first external presentation device.

2. A method as in claim 1, wherein the user interface is a touch-sensitive display.

3. A method as defined in claim 2, wherein the selection is made on the touch-sensitive display by touching a portion of the touch-sensitive display located within the bounds of a display of the first application.

4. A method as in claim 2, wherein the indication represents a touch on a touch-sensitive display of the first external presentation device.

5. A method as defined in claim 1, wherein the communication link is a Bluetooth communication link.

6. A method as defined in claim 5, wherein the Bluetooth communication is established using close proximity communications.

7. A method as defined in claim 6, wherein the close proximity communications comprises near-field communications.

8. A method as defined in claim 1, further comprising:
receiving, via a user interface of the first external presentation device, a second selection of a second application to be displayed on a second external presentation device;
receiving a second indication that the second external presentation device was selected to display the second application; and
displaying the second application on the second external presentation device.

9. A method as defined in claim 8, wherein the first application is different from the second application.

10. A method as defined in claim 1, wherein the mobile device is a smartphone.

11. A method comprising:
receiving, via a user interface of the first external presentation device, a first selection of a first application to be displayed on a destination external presentation device;
receiving a first indication, via a user interface of a second external presentation device, that the second external presentation device was selected as the destination external presentation device to display the first application; and
causing the first application to be displayed on the second external presentation device.

12. A method as defined in claim 11, further comprising:
establishing a first communication link between a mobile device and the first external presentation device; and
establishing a second communication link between the mobile device and the second external presentation device.

13. A method as defined in claim 12, wherein the first indication is received at the mobile device.

14. A method as defined in claim 11, further comprising establishing a second communication link between the first external presentation device and the second external presentation device.

15-28. (canceled)

29. A mobile wireless communication device comprising:
a housing;
a display carried by the housing;
a wireless receiver and transmitter carried by the housing;
a processor carried by the housing, coupled to the wireless receiver and transmitter, and coupled to the display, the processor configured to:
establish a communication link between the mobile wireless communication device and a first external presentation device;
receive, via a user interface of the mobile wireless communication device, a first selection of a first application to be displayed on a destination external presentation device;
receive, at the mobile wireless communication device, a first indication via the communication link that the first external presentation device was selected as the destination external presentation device for the first application; and
cause the first application to be displayed on the first external presentation device.

30. A mobile wireless communication device as in claim 29, wherein the user interface is a touch-sensitive display.

31. A mobile wireless communication device as defined in claim 30, wherein the selection is made on the touch-sensitive display by touching a portion of the touch-sensitive display located within the bounds of a display of the first application.

32. A mobile wireless communication device as in claim 30, wherein the indication represents a touch on a touch-sensitive display of the first external presentation device.

33. A mobile wireless communication device as defined in claim 29, wherein the communication link is a Bluetooth communication link.

34. A mobile wireless communication device as defined in claim 33, wherein the Bluetooth communication is established using close proximity communications.

35. A mobile wireless communication device as defined in claim 34, wherein the close proximity communications comprises near-field communications.

36. A mobile wireless communication device as defined in claim 29, wherein the processor is configured to:
receive, via a user interface of the first external presentation device, a second selection of a second application to be displayed on a second external presentation device;
receive a second indication that the second external presentation device was selected to display the second application; and
display the second application on the second external presentation device.

37. A mobile wireless communication device as defined in claim 36, wherein the first application is different from the second application.

38. A mobile wireless communication device as defined in claim 29, wherein the mobile wireless communication device is a smartphone.

39-42. (canceled)
